(19) United States
(12) Patent Application Publication
(10) Pub. No.: US 2006/0080412 A1
(43) Pub. Date: Apr. 13, 2006

(54) Method and system for establishing a server template for an application deployment

(75) Inventors: Andrei Oprea, Toronto (CA); Razvan C. Peteanu, North York (CA)

Correspondence Address: International Business Machines;Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/870,223

(22) Filed: Jun. 17, 2004

(51) Int. Cl. G06F 15/177

(52) U.S. Cl. 709/220

(57) ABSTRACT

The server template groups the configuration elements that have to be applied to a group of similar servers (e.g. a cluster of servers) in a structured entity, decoupling the set of parameters from the element those configurations are implemented for. The server template encapsulates the configuration elements that have to be applied to a server. It specifies the networking elements that will be configured (number of NICs, the VLAN each one of the NIC will be in, how many network interfaces on each NIC, the subnets those network interfaces will be configured in, the routes that will be configured on the server), the software that will have to be installed on the server once configured, the way the configured server will participate in a defined cluster.

### CROSS-REFERENCE To RELATED APPLICATIONS

United States Patent applications entitled “Method and System for Managing Application Deployment” and “Method and System for Establishing a Deployment Plan for an Application” were filed concurrently herewith.

### FIELD OF INVENTION

The present invention relates to the field of application deployment management. In particular, to a system and a method for establishing a server template for an application deployment.

### BACKGROUND

Deployment of applications in environments, such as a data centre or a testing environment, involves a complex setup process which is often done manually for each separate deployment. The deployment setup can involve a combination of both common components that are specific to the application but are not dependent on the environment and components that are specific to the environment. When an application is deployed in different environments using the manual process, the deployment setup is manually recreated for each new environment even if there are components that are common for every deployment of the application. This redundancy in the specification of the common components for the application is cumbersome and can introduce errors and inconsistencies between different but similar deployments.

Further, since the deployment setup is a manual process, the requirements of the application are conceptualized by a use employing actual resources available in the data center. Preservation of such a logical view of the deployment would enable flexibility in the assignment of resources for the deployment of the application.

### SUMMARY OF INVENTION

The server template groups the configuration elements that have to be applied to a group of similar servers (e.g. a cluster of servers) in a structured entity, decoupling the set of parameters from the element those configurations are implemented for.

The server template encapsulates the configuration elements that have to be applied to a server. It specifies the networking elements that will be configured (number of NICs, the VLAN each one of the NIC will be in, how many network interfaces on each NIC, the subnets those network interfaces will be configured in, the routes that will be configured on the server), the software that will have to be installed on the server once configured, the way the configured server will participate in a defined cluster.

In accordance with one aspect of the present invention, a system for establishing a server template containing configuration requirements for the deployment of an application having as input a logical application structure defining logical elements of the application, a logical deployment template defining nodes for supporting deployment of the logical elements and a network topology template defining configuration elements for resolving dependencies between the nodes, the system comprising: an application mapping mechanism for mapping the application elements identified in the logical application structure onto the nodes defined in the logical deployment template; a pool identification mechanism for identifying hardware resources associated with a node that have the same configuration requirements as a pool; a networking requirements mechanism for resolving the network connection configuration requirements in the logical deployment template using the network topology template; and a template mechanism for generating the server template containing the configuration requirements for the hardware resources in the pool..

In accordance with another aspect of the present invention, a method for establishing a server template containing configuration requirements for the deployment of an application having as input a logical application structure defining logical elements of the application, a logical deployment template defining nodes for supporting deployment of the logical elements and a network topology template defining configuration elements for resolving dependencies between the nodes, the system comprising the steps of: a) obtaining a logical application structure defining logical elements of the application, a logical deployment template defining nodes for supporting deployment of the logical elements and a network topology template defining configuration elements for resolving dependencies between the nodes; b) mapping the application elements identified in the logical application structure onto the nodes defined in the logical deployment template; c) identifying hardware resources associated with a node that have the same configuration requirements as a pool; d) resolving the networking requirements expressed in the logical deployment template using the network topology template; and e) generating a server template that each contains the configuration requirements for the identified hardware resources in the pool..

In accordance with still another aspect of the present invention, a computer program product for establishing a server template containing configuration requirements for the deployment of an application having as input a logical application structure defining logical elements of the application, a logical deployment template defining nodes for supporting deployment of the logical elements and a network topology template defining configuration elements for resolving dependencies between the nodes, the computer program product comprising: computer readable program code devices for: a) obtaining a logical application structure defining logical elements of the application, a logical deployment template defining nodes for supporting deployment of the logical elements and a network topology template defining configuration elements for resolving dependencies between the nodes; b) mapping the application elements identified in the logical application structure onto the nodes defined in the logical deployment template; c) identifying hardware resources associated with a node that have the same configuration requirements as a pool; d) resolving the networking requirements expressed in the logical deployment template using the network topology template; and e) generating a server template that each contains the configuration requirements for the identified hardware resources in the pool.

Other aspects and features of the present invention will become apparent to those ordinarily skilled in the art to which it pertains upon review of the following description of specific embodiments of the invention in conjunction with the accompanying figures.

### BRIEF DESCRIPTION OF DRAWINGS

The present invention will be described in conjunction with the drawings in which:

FIG. 1 illustrates a system for managing the deployment of an application;

FIG. 2 illustrates a method of establishing a server template;

FIG. 3 illustrates a server deployment mechanism of the system in FIG. 1; and

FIG. 4 is a graphical representation of an exemplary deployment plan containing a server template.

### DETAILED DESCRIPTION

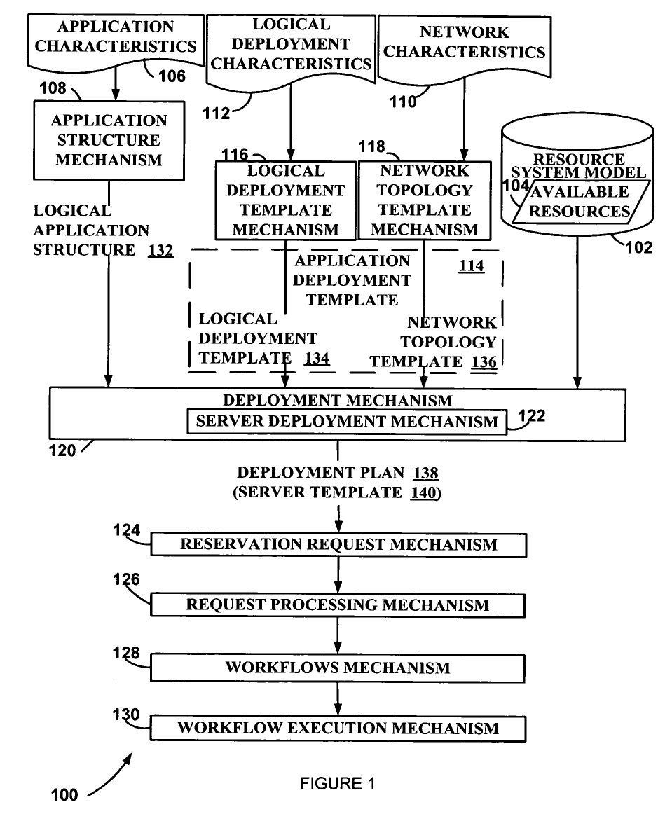

FIG. 1 illustrates a system 100 for managing the deployment of an application using resources in a resource system (not shown), such as a data center. The system 100 balances the availability of resources in the resource system and characteristics describing the desired configuration of these resources with resource requests from the application for execution thereof. An exemplary system 100 is described in detail in commonly owned co-pending application titled “Method and System for Managing Application Deployment”, filed concurrently herewith and incorporated herein by reference.

The resources in the resource system are represented in a resource system model 102 containing data on available resources 104. The available resources 104 may be any resource used for the execution of an application, including servers, routers, software licenses, etc., which has available capacity. The data on the available resources 104 includes information on the characteristics and configurability of each resource in the resource system model 102 that is germane to the resource system. Such information can include total resource capacity, available capacity, speed, communication protocols, etc. The resource system model 102 also represents the relationships between the available resources 104 where applicable, such as connections between servers, etc.

The application is considered to be composed of multiple elements which are the distinct deployable units. The application is broken down such that each element contains a small amount of application functionality but still retains its distinct deployability. Each element has a known type that is used for processing the deployment of the application.

The application structure mechanism 108 receives application characteristics 106 and produces a logical application structure 132 therefrom for use by other mechanisms in the system 100. The application characteristics 106 represent resources and their configurations that may be used for deployment of the application. The logical application structure 132 contains a characterization of resource dependencies for each element. The application may be successfully deployed when these resource dependencies are satisfied.

Logical deployment characteristics 112 and network characteristics 110 are received by a logical deployment template mechanism 116 and a network topology template mechanism 118, respectively. The logical deployment characteristics 112 are specified by a user to provide a logical view of the desired characteristics of the configuration of a desired deployment. The networking characteristics 110 are specified by a user to depict communication connections between resources. The network characteristics 110 and the logical deployment characteristics 112 are used by the mechanisms 116 and 118 to form an application deployment template 114 that sets out the desired characteristics of a deployment (not specific to the current application being deployed) in a manner that can be used in determining deployment of resources.

The logical deployment template mechanism 116 receives the logical deployment characteristics 112 and produces a logical deployment template 134. The logical deployment template 134 describes from a logical view how different types of elements that could compose the application are to be deployed according to various types of resources. The logical deployment template 134 contains a logical characterization of a desired deployment. The network topology template mechanism 118 receives the network characteristics 110 and forms a network topology template 136. The network topology template 134 describes the network connections for different types of elements that could be in the application. The network topology template 136 contains a network characterization of the desired deployment. The logical deployment template 134 and the network topology template 136 together form the application deployment template 114.

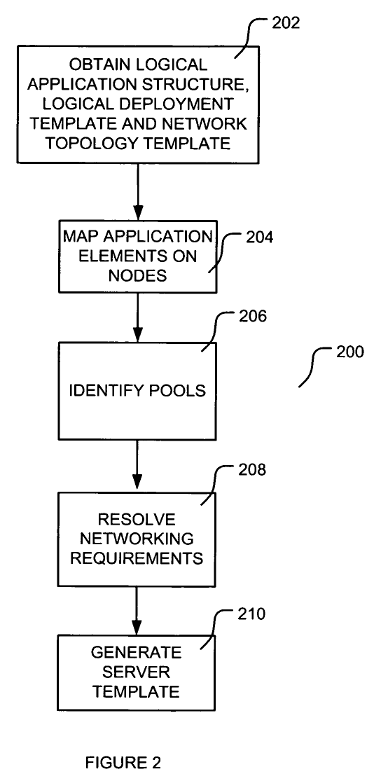

A deployment mechanism 120 receives the logical deployment template 134, the network topology template 136 and the logical application structure 132 to develop a deployment plan 138 which contains the target software and hardware configurations to be implemented for the deployment of the application. The deployment plan 138 presents a logical view of the deployment configuration showing functional components which may actually consist of multiple hardware and/or software resources having a particular configuration and performing a specific function. The networking configuration and the hardware to support this configuration for the deployment are outlined in the deployment plan 138 along with the dependencies between elements that are depicted in the logical application structure 132. The deployment plan 138 provides a high level deployment solution for the application given the logical application structure 132 in the environment described in the network topology template 136 and the logical deployment template 134. The deployment mechanism 120 will be discussed later in conjunction with FIG. 2.

An exemplary deployment mechanism 120 is described in detail in commonly owned co-pending application titled “Method and System for Establishing a Deployment Plan for an Application,” filed concurrently herewith and incorporated herein by reference.

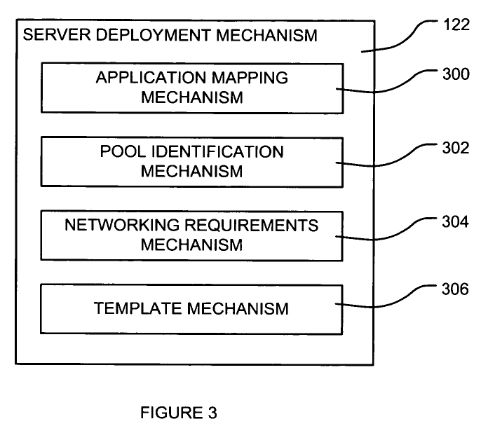

Within the deployment plan 138, servers may be treated as separate resources or multiple servers may be grouped together to form a cluster. Each server in a cluster (or each of some other resource in a cluster) can have the same configuration. The deployment mechanism 120 contains a server deployment mechanism 122 that produces a server template 140 containing configurations for server clusters for the deployment. The server deployment mechanism 122 will be discussed later in conjunction with FIGS. 3-5.

The deployment plan 138 with the server template 140 are provided to a reservation mechanism 124 which forms a request for the resources identified in the deployment plan 138. This request is provided to request processing mechanism 126 of the system where the resources request is reviewed.

The request processing mechanism 126 coordinates all requests for resources in the resource system with the available resources 104. While the deployment plan 138 provides a logical conceptual view of the deployment solution, the request processing mechanism 126 translates that conceptual view into a more physical actual depiction of the deployment including specifying individual resources that are to be assigned in the deployment and the configuration of those resources.

The resources that are to be deployed and the configuration that these resources are to be given is communicated to a workflows mechanism 128 so that a workflow to deploy these resources can be created. The workflow to deploy the application is provided to a workflow execution mechanism 130 for implementation.

FIG. 2 is a flow diagram representing the steps in the method 200 for establishing a server template 140 for an application deployment according to an exemplary embodiment of the present invention. The server template groups the configuration requirements that are to be applied to a group of resources (e.g. a pool of servers) into a single structured entity.

In step 202 a logical application structure 132, a logical deployment template 134 and a network topology template 136 are obtained. The logical application structure 132 identifies the application elements, including their types, of the application to be deployed.

Step 204 is the mapping of the application elements identified in the logical application structure 132 onto the nodes contained in the logical deployment template 134. This mapping is achieved by matching the types of the application elements with the element types hosted by the nodes. The mapping of the application elements onto the nodes permits the configuration requirements associated with each of the application elements to be generated. The logical application structure 132 specifies resources requirements, associated with each node type, such as, for example, the hardware requirements (e.g. processor and memory specifications), the software requirements (e.g. the software stack from the application layer to the operating system layer) and the network requirement (e.g. logical connections) that must be provided by a node to which an application element is assigned.

Clusters of hardware resources may form each node. One or more of the hardware resource in a cluster can have the same configuration requirements. Where more than one hardware resource has the same configuration requirements, the resources form a pool. In step 206 pools are identified.

In step 208, the network related configuration requirements are elaborated by resolving the networking requirements arising from the logical structure (e.g. cluster information) expressed in the logical deployment template 134 using the network topology template 136. The connections requirements of the logical deployment template are elaborated into configurations requirements including, for example, identification and specification of virtual local area networks (VLAN), identification and specification of sub networks (subnets), node connections to the VLAN and subnets, network interface card (NIC) requirements, network port assignments, internet protocol (IP) address assignments, firewall requirements and router assignments and requirements. The specified resources may be sharable resources. Specified resources can be logical resources based on type and specification with actual assignment to a specific datacenter resource deferred to a later phase of the application deployment.

In step 210 server templates 140 are generated for each pool. A server template 140 can be used to represent the configuration requirements for each of the hardware resources in a pool. The configuration. requirements contain sections related to, for example, configuration information for route destinations, gateways, subnetworks, network interface cards (NIC), virtual local area networks (VLAN) and hosting software stacks. The server deployment mechanism 122 can generate a server template 140 for each identified pool.

The server template 140 can be, for example, an extensible markup language (XML) structure that contains sections related to configuration information for route destinations, gateways, subnetworks, network interface cards, virtual local area networks and hosting software stacks that the application deployment will be realized on. The one or more server templates 140 can be contained in a deployment plan 138, for example, one for each cluster or pool that will be created as part of the application deployment.

The server template 140 can encapsulate the configuration parameters for a server in a cluster, a pool or it can be a standalone template that can be used to express the known elements of a configuration, decoupling the set of parameters from the server those configurations are implemented for.

The server template 140 can be co-generated with, and as part of, a deployment plan 138 in accordance with commonly owned co-pending application titled “Method and System for Establishing a Deployment Plan for an Application.”

Other templates can also tie into the server template 140, like storage or virtualization templates.

The server template 140 specifies the known coordinates of a server once it will be configured. The level of specificity can vary in order to obtain templates with different enforcement strengths, thus allowing for different degrees of flexibility when the actual configuration is done.

FIG. 3 illustrates the server deployment mechanism 122 of the system 100 of FIG. 1. The server deployment mechanism 122 comprises an application mapping mechanism 300, a pool identification mechanism 302, a networking requirements mechanism 304 and a template mechanism 306. The application analysis mechanism 300 maps the application elements identified in the logical application structure 132 onto the nodes contained in the logical deployment template 134. This mapping is achieved by matching the types of the application elements with the element types hosted by the nodes. The pool identification mechanism 302 identifies one or more of the hardware resource in a cluster that have the same configuration requirements. The networking requirements mechanism 304 elaborates the network related configuration requirements by resolving the networking requirements arising from the logical structure (e.g. cluster information) expressed in the logical deployment template 134 using the network topology template 136. The template mechanism 306 generates the server templates 140 containing configuration requirements for the logical nodes (e.g. hardware resources) in any identified pool and the network connections between the logical nodes.

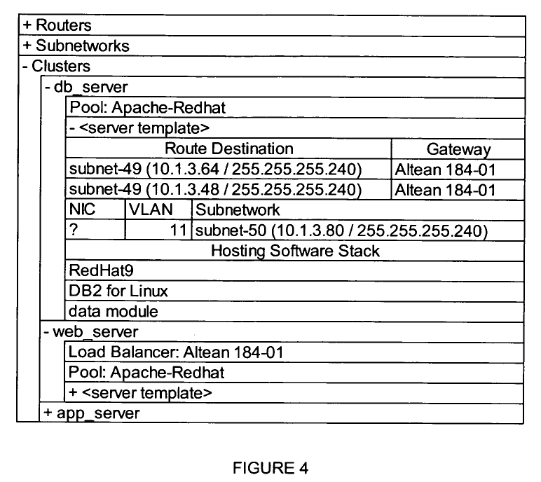

FIG. 4 is a graphical representation of an exemplary deployment plan. The deployment plan 138 is hierarchically organized and contains a server template 140 according to the present invention. Top level sections of the deployment plan 138 illustrated are related to routers, subnetworks and clusters. The clusters section is expanded to show clusters related to a database server (db_server), a web server (web_server) and an application server (app_server). The database server (db_server) cluster is expanded to show a pool association and an associated server template 140. The server template 140 contains sections related to configuration information for route destinations, gateways, subnetworks, network interface cards (NIC), virtual local area networks (VLAN) and hosting software stacks.

The specific configuration elements and parameters contained in the server template 140 shown in FIG. 4 are illustrative. Other similar configuration elements and parameters can be included in the server template 140 while remaining within the spirit and scope of the present invention.

Embodiments of the present invention may be implemented in any conventional computer programming language. For example, embodiments may be implemented in a procedural programming language (e.g. “C”) or an object oriented language (e.g. “C++”). Further embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g. a diskette, CD-ROM, ROM, or fixed disk) or transmittable to a computer system, via a modem or other interface device, such as a communications adapter connected to a network over a medium. The medium may be either a tangible medium (e.g. optical or electrical communications lines) or a medium implemented with wireless techniques (e.g. microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g. shrink wrapped software), preloaded with a computer system (e.g., on system ROM or fixed disk), or distributed from a server over the network (e.g., the Internet or World Wide Web). Some embodiments of the invention may be implemented as a combination of both software (e.g. a computer program product) and hardware (termed mechanisms). Still other embodiments of the invention may be implemented as entirely hardware, or entirely software (e.g. a computer program product).It will be apparent to one skilled in the art that numerous modifications and departures from the specific embodiments described herein may be made without departing from the spirit and scope of the present invention.

1. A system for establishing a server template comprising configuration requirements for the deployment of an application, the system receiving a logical application structure defining logical elements of the application, a logical deployment template defining nodes for supporting deployment of the logical elements and a network topology template defining configuration elements for resolving dependencies between the nodes, the system comprising:
an application mapping mechanism for mapping the logical elements identified in the logical application structure onto the nodes defined in the logical deployment template;
a pool identification mechanism for identifying hardware resources associated with a node that have the same configuration requirements to form a pool;
a networking requirements mechanism for resolving network connection configuration requirements in the logical deployment template using the network topology template; and
a template mechanism for generating the server template containing the configuration requirements for the hardware resources in the pool.

2. The system of claim 1, said server template comprising configuration requirements for nodes assigned to a pool and identification of said pool.

3. The system of claim 1, wherein said server template is an extended mark-up language (XML) structure.

4. The system of claim 1, wherein said logical application structure is specific to the application.

5. The system of claim 1, wherein said application deployment template is derived from a logical deployment characteristic set that is non-application specific and from a network characteristic set that is non-application specific.

6. A method for establishing a server template comprising configuration requirements for the deployment of an application using a logical application structure defining logical elements of the application, a logical deployment template defining nodes for supporting deployment of the logical elements and a network topology template defining configuration elements for resolving dependencies between the nodes, the system comprising the steps of:
a) obtaining a logical application structure defining logical elements of the application, a logical deployment template defining nodes for supporting deployment of the logical elements and a network topology template defining configuration elements for resolving dependencies between the nodes;
b) mapping the logical elements identified in the logical application structure onto the nodes defined in the logical deployment template;
c) identifying hardware resources associated with a node that have the same configuration requirements to form a pool;
d) resolving networking requirements expressed in the logical deployment template using the network topology template; and
e) generating a server template that each contains the configuration requirements for the identified hardware resources in the pool.

7. The method of claim 6, said server template comprising configuration requirements for nodes assigned to clusters and pools and identification of said clusters and pools.

8. The method of claim 6, wherein said server template is an extended mark-up language (XML) structure.

9. The method of claim 6, wherein said logical application structure is specific to the application.

10. The method of claim 6, wherein said application deployment template is derived from a logical deployment characteristic set that is non-application specific and from a network characteristic set that is non-application specific.

11. A computer program product for establishing a server template comprising configuration requirements for the deployment of an application using a logical application structure defining logical elements of the application, a logical deployment template defining nodes for supporting deployment of the logical elements and a network topology template defining configuration elements for resolving dependencies between the nodes, the computer program product comprising:
computer readable program code devices for:
a) obtaining a logical application structure defining logical elements of the application, a logical deployment template defining nodes for supporting deployment of the logical elements and a network topology template defining configuration elements for resolving dependencies between the nodes;
b) mapping the logical elements identified in the logical application structure onto the nodes defined in the logical deployment template;
c) identifying hardware resources associated with a node that have the same configuration requirements to form a pool;
d) resolving networking requirements expressed in the logical deployment template using the network topology template; and
e) generating a server template that each contains the configuration requirements for the identified hardware resources in the pool.

12. The computer program product of claim 11, said server template comprising configuration requirements for nodes assigned to a pool and identification of said pool.

13. The computer program product of claim 11, wherein said server template is an extended mark-up language (XML) structure.

14. The computer program product of claim 1 1, wherein said logical application structure is specific to the application.

15. The computer program product of claim 11, wherein said application deployment template is derived from a logical deployment characteristic set that is non-application specific and from a network characteristic set that is non-application specific.
